(19) United States
(12) Patent Application Publication
(10) Pub. No.: US 2019/0311390 A1
(43) Pub. Date: Oct. 10, 2019

(54) Methods and Systems for Gathering and Display of Responses to Surveys and Providing and Redeeming Rewards

(71) Applicant: SurveyMe Limited, Stockport (GB)

(72) Inventors: Lee Evans, Stockport (GB); Stephen Shallcross, Stockport (GB)

(21) Appl. No.: 16/376,417

(22) Filed: Apr. 5, 2019

Related U.S. Application Data
(60) Provisional application No. 62/653,187, filed on Apr. 5, 2018.

(51) Int. Cl. G06Q 30/02

(52) U.S. Cl. CPC G06Q 30/0225; G06Q 30/0233; G06Q 30/0217; G06Q 30/0203

(57) ABSTRACT

Systems and methods are described for selecting and presenting one or more surveys to a user based on a captured image or other information. Upon completion of the survey, a reward can be sent to the user. The reward can be redeemed by first clearing the reward using a captured image and location information of the user device to determine whether the redemption may be fraudulent. Manners for sharing surveys and creating new surveys and rewards are also described.

This application claims priority to U.S. provisional application having Ser. No. 62/653,187 filed on Apr. 5, 2018. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is systems and methods for management of surveys and the redemption of coupons and other rewards.

### BACKGROUND

The following description includes information that may be useful in understanding the present invention. It is not an admission that any of the information provided herein is prior art or relevant to the presently claimed invention, or that any publication specifically or implicitly referenced is prior art.

Surveys have existed for quite some time but they are generally not well targeted and often not completed due to a lack of incentives. They are also broadly sent rather than targeted to individual locations of a user. While it is known to offer a set reward for completion of a survey, this is often done by a specific entity to a target group known to them.

When rewards are offered, this often increases the likelihood of fraud as people may try to obtain multiple rewards for completing a survey multiple times, or may simply forge a reward and attempt to redeem it. Certain attempts have been made such as by using unique identifier codes for a specific reward that can only be redeemed once, but this again is usually limited to a specific merchant targeting their own clientele, and is not widely utilized outside of that group.

Other issues with reward redemption, and particularly coupon redemption, include miscounting of coupons leading to over- or underpayment of merchants. This is because paper coupons must typically be scanned, stored and mailed out, and manual counting is required to determine the amount owed.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for providing surveys and rewards to consumers based on their location, and verifying redemption of rewards to increase accuracy and prevent fraud.

### SUMMARY OF THE INVENTION

The inventive subject matter provides apparatus, systems and methods in which a system can facilitate the provision and management of one or more surveys to users. Such system is also preferably configured for distribution and management of rewards. Such rewards may include, for example, coupons, gift cards, special offers, and so forth. The inventive subject matter described herein relates to the processes required to create surveys, provide such surveys to users, gather and store survey responses, and the processing and delivery of data from the gathered surveys to provide simultaneous value to both the users and the entity that created a survey. Rewards can be provided for the completion and sharing of surveys.

In some embodiments, surveys can be provided to users based on information obtained from a captured image using image recognition such as via a mobile phone application. Preferred systems and methods can simultaneously deliver real-time feedback to a survey creator and redeemable rewards to users, while also providing a digital reward coupon scanning and clearing system.

The inventive subject matter advantageously can be used to garner user loyalty, establish a trackable user base, and ensure that subsequent surveys/rewards are noticed and taken. This provides value to future clients through having a pool of users that could take their survey. A primary method to establish loyalty is to offer an instant reward to the user who takes the survey. This can be then built upon by offering bonus rewards after the user has shared the survey via, but not limited to, social media, email or SMS.

These rewards can be static coupons to be redeemed at a point of sale, or can contain a redemption code unique to the user, for example.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary flow chart of one embodiment of a method for managing surveys and rewards.

FIG. 2 illustrates a flowchart of one embodiment of a method for selecting and providing a user with a survey.

FIG. 3 illustrates a diagram of one embodiment of a server used to process received images.

FIGS. 4-6 illustrate various embodiments of user interfaces.

FIG. 7 illustrates an exemplary user interface for accessing survey creation tools and reports.

FIGS. 8-13 illustrate various embodiments of user interfaces for creating a survey.

FIGS. 14-18 illustrate various embodiments of user interfaces for creating and viewing reports concerning survey completion.

FIGS. 19-22 illustrate examples of various user interfaces that can be used to create/add a reward to a survey.

FIG. 23-25 illustrate various embodiments of user interfaces for sharing a survey.

FIG. 26 illustrates one embodiment of a user interface for presenting a customized message with a link to a software application or survey.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

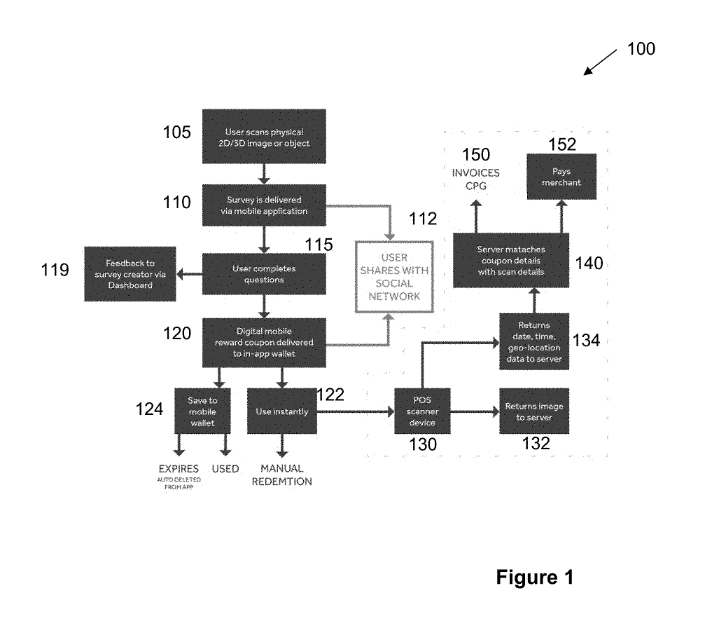

FIG. 1 illustrates an exemplary flow chart of one embodiment of a method 100 for managing surveys and rewards. In step 105, a user can scan or otherwise capture a physical two- or three-dimensional image or object using the user computing device (user device). Such user computing devices can include, for example, a smart phone (e.g., Apple™ iPhone™), a smart watch (e.g., Apple Watch™), smart glasses, tablet PCs, or other portable computing devices.

Preferably, the user computing device is configured to include a module for capturing an image, such as a camera. Information from the captured image can then be used to identify a surveying entity and a subject-specific survey area or other auxiliary information. The module can communicate to a server the captured image, information derived from the image, and/or related information such as location and time/date where the image was taken.

In response to receiving the information, the server is configured to select survey content related to the received image or image information, and communicate this selected subject-specific survey content to the user device in step 110. It is contemplated that the selection of survey content could also be based on one or more of a user device's location, a user device type, a user's profile, a list of a user's completed surveys, and so forth.

In step 115, the user responds to the provided subject-specific survey content (i.e., completes the survey), and the survey response information from the user is provided to the server.

Responses to surveys can be processed and stored by a server, which could be the same or different from the server discussed above. Information that can be included with the survey responses includes, for example, a location from which each response was transmitted, a location from which each survey was requested, user identifying information, user device type, and so forth. The location information can be derived from the user device, and may include latitude and longitude of a user device location and/or network metadata of an incoming data packet from the user device.

In preferred embodiments, the survey response information from the user is transmitted from the user device automatically after completion of the last question in the survey, and a reward can be instantly or near-instantly delivered and presented on the screen of the user device in step 120. It is preferred that a user receives a reward immediately or soon after completing the survey to encourage further user interaction. In this manner, the described methods set forth a digital reward-earning platform using a software application on a user device application and a control program running on a server, which is used to encourage users to provide feedback by rewarding the users with virtually- and/or physically-redeemable coupons or other rewards delivered directly to the user device when a survey is completed.

In step 122, the digital reward can be used instantly by the user. Alternatively, in step 124, the digital reward can be saved in a virtual wallet within the mobile software application on the user device for future redemption, such as described below.

In some embodiments, digital rewards such as coupons can be defined by a coupon specification received from a coupon issuer. Digital coupons and other rewards can be issued to users and redeemed at third party retailer websites and/or point of sale systems in store. Upon redemption of a coupon or other reward, a module within the user device's software application can facilitate clearing of the coupon via interaction with a reward server that acts as an electronic coupon clearing house where the reward server manages the distribution of rewards, redemption of rewards, reimbursement of retailers and invoicing of coupon issuers. In some embodiments, the reward server can be a server distinct from the server described above, while in other embodiments, the reward server can be the same as the server.

In some embodiments, to redeem a coupon or other reward, a user may cause the reward to be scanned by a point-of-sale (POS) scanner device, such as shown in step 130. This could be, for example, at a brick and mortar retail store, where physical coupons may also be redeemed.

For example, a user can click to redeem a reward, which may present the electronic reward on the screen of the user device. The presented reward preferably has information such as a manufacturer's product QR code, bar code or other identifier. A retailer may use its POS system to recognize the information on the presented reward similar to how the POS system would historically recognize a paper version of a manufacturer's coupon.

After the identifier is scanned by the POS device, the software application causes the user device to capture an image using the user device's camera, for example. However, it is also contemplated that the software application could cause the user device to capture a series of images during the redemption process, and then select and transmit one or more of the images that most likely captured the redemption event (e.g., scanning of the reward). This may be, for example, the image that includes the POS device. The captured image can then be stored within the software application on the user device. Thus, in some embodiments, once the reward is displayed on the user device, the software application can cause the user device to begin capturing images periodically using the user device's camera, for example. In one embodiment, images can be captured every 0.25 seconds. The image capturing can continue until the software application receives notification that the reward was redeemed and/or accepted. Such notification could be from the reward server or from the POS system.

The captured images can then be processed, such that a subset of the captured images is selected that most likely show the redemption event. This subset of one or more images can then be sent to the reward server. Preferably, a time/date and location of the user device when the image(s) were captured is sent along with the subset of images.

In some embodiments, the POS scanner can trigger the capture of the image by the user device, such as by a laser on the POS scanner triggering the camera feature via the software application. In other embodiment, the successful scanning of the identifier by the POS scanner relays a message to the user device that the reward has been scanned and to capture an image of the redemption event.

The time, date and location of the user device when it interacted with the POS device or when the image(s) of the redemption event were captured is also recorded by the user device and transmitted to the reward server along with the image(s) in step 134.

After the image of the redemption event by the user device, the software application is configured to remove the coupon or other reward from the user device's screen to prevent its reuse. The software application sends the captured image in step 132 to the reward server whereupon the captured image is read and the reward is cleared. Once received by the reward server, the captured image can be automatically linked to a manufacturer's user id and the survey identifier is counted.

In other words, the laser on the POS device can trigger the user device to capture an image of the redemption event (i.e., what is occurring in front of the user device at the time of redemption of the reward) if the user device is not already capturing a series of images as described above. It is contemplated that the captured image(s) are is not visible to the user and would not be stored with the user's other photos, for example. Rather, the captured image(s) would be stored within the software application such that they do not appear, and are not stored, anywhere visibly on the user device. The reward server (i.e. the MIDLAY™ system) then receives and stores the captured image(s). The reward server sends an instruction to the software application on the user device to delete any stored images held within the software application on the user device, to prevent fraud. The deletion of the image(s) on the user device can also cause the software application to present an interface that confirms redemption of the reward.

After receiving the captured image(s), the reward server processes the image(s) using one or more image recognition algorithms, and assigns the image a reliability score. The score is preferably based at least in part on the similarity of the image to known images of POS equipment. As such, prior to redemption, such known images are preloaded onto the reward server to “train” the image recognition algorithm to recognize POS equipment in captured images. Presumably, at the time the image is captured, the POS device would be in front of the user device's camera such that the POS device can scan the identifier on the user device. Thus, the user device would likely capture the POS device in the captured image. Where a POS device is present in the captured image, the assigned score for that image would be higher than where a POS device is not present or is not clearly present.

The assigned score of the image can then be used, in conjunction with the proximity of the redemption (using the location and/or other data provided to the reward server by the user device) compared to a retailer's known locations, to flag redemption events for further analysis/fraud analysis. For example, a redemption event could be flagged if the redemption event occurred outside of a predefined range of a retailer's known locations, and/or if a POS device is not present in the captured image.

It is contemplated that redemption event image data from prior redemption by users can periodically be used to refine and further train the image recognition algorithms.

Although the above description discusses the capturing of an image using the user device's camera or other image capture device, it is also contemplated that a screen capture of the reward itself on the user device could be taken instead or in addition to the captured image described above.

The reward server matches the coupon details with information from the user device (e.g., the captured image and time, date and location of the reward redemption) in step 140. This can include, for example, attaching a survey ID (which is connected to the redeemed reward) and a retailer's location ID (i.e., the location where the captured image triggered by the POS device occurs) to the coupon details.

Thus, the time, date and location of the user device of the reward redemption when the user device interacted with the POS device is also recorded on the reward server, and the reward server may allocate rewards based on preloaded geolocation coordinates of the retailer.

By capturing and storing the above-described information, the reward server can generate one or more reports that detail how many rewards were redeemed/captured, as well as when and where the rewards were redeemed and an amount owed to the retailer for their redemption. The reward server can also be configured to generate an invoice for a manufacturer or other entity (CPG) who authorized the reward in step 150. Detailed information about the redeemed rewards can be accessed by such entities by logging onto their secure accounts. This advantageously provides information about how many coupons a merchant has processed and the amount owed to that merchant based on the redeemed coupons so the merchant can be paid in step 152.

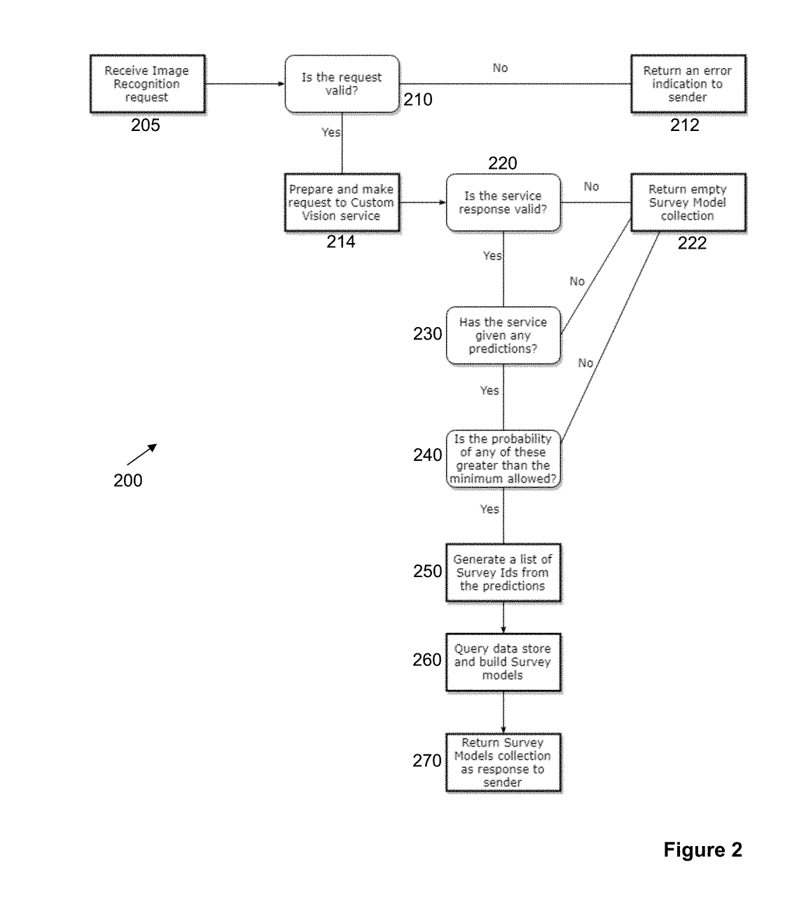

FIG. 2 illustrates a flowchart of one embodiment of a method 200 for selecting and providing a user with a survey. An image captured by a user device and/or information related to the captured image can be received at a server in step 205 from a user device, for example. It is contemplated that the user device can pre-process and compress the image as needed to reduce the bandwidth required. Although preferred image sizes are no greater than 500 KB, the specific image size may vary especially as throughput and upload speeds increase over time. Such compression can be accomplished using techniques such as reducing the resolution of the image or other techniques known in the art such as cropping, coloring, and so forth.

The image is transferred to the server (also referred to herein as the MIDLAY™ server). Such transfer preferably occurs wirelessly form the user device to the server such as using Wi-Fi other connection. The transfer may occur using the https protocol, for example, although other protocols could be used without departing from the scope of the invention.

Upon receipt of the captured image, the server will analyze the image to validate the received information in step 210. For the image recognition process by the server, the server is preferably preloaded and trained with a selection of images of the object/image to be recognized. These images can be tagged with metadata containing an identifier unique to the survey to be provided to the end user based on the object/image.

Examples of objects include, for example, movie posters and other promotional fliers, statues, signs, magazines, ticket stubs, images, and so forth. Thus, for example, if a user takes an image of a movie poster, the user may receive a survey and/or reward related to the movie shown on the poster.

If the image cannot be validated, the server returns an error to the user device in step 212.

If the image is validated, the server prepares a request object for image recognition software (also referred to as “Custom Vision”) in step 214. In some embodiments, the image data is converted into a stream object, and along with the Custom Vision service API security key and the iteration to use, is submitted for processing by the image recognition process. The image recognition process generates a response, and the server reviews the response to verify the validity of the image in step 220.

If the response is invalid, an empty list of surveys or error message is returned to the user device in step 222 and the image recognition process ends.

If the response is valid (e.g., the server recognizes an object or item in the image), the process reviews to determine if any predictions were generated during the image recognition process about which survey is a match in step 230. If no predictions are made, an empty list of surveys or error message is returned to the user device in step 222. If one or more predictions are made, the server examines the predictions to determine which of those predictions (e.g., selected surveys) have a probability greater than the minimum allowed in step 240. The list of survey identifiers meeting the requirements is then generated in step 250 from the metadata of those surveys that exceed the minimum probability of accuracy (e.g., those surveys that are likely to be relevant based on the image received by server).

The server then populates a list of surveys from the data store on the server or another server that matches the list of survey identifiers in step 260. Once populated, this list can be returned to the user device in step 270. In some embodiments, it is contemplated that the list can be returned as a JSON formatted collection of surveys.

In some embodiments, when the result is received by the user device, if only one survey is returned, that survey will automatically open. If there are multiple surveys, then the user may be shown a choice in order of probability of the surveys returned.

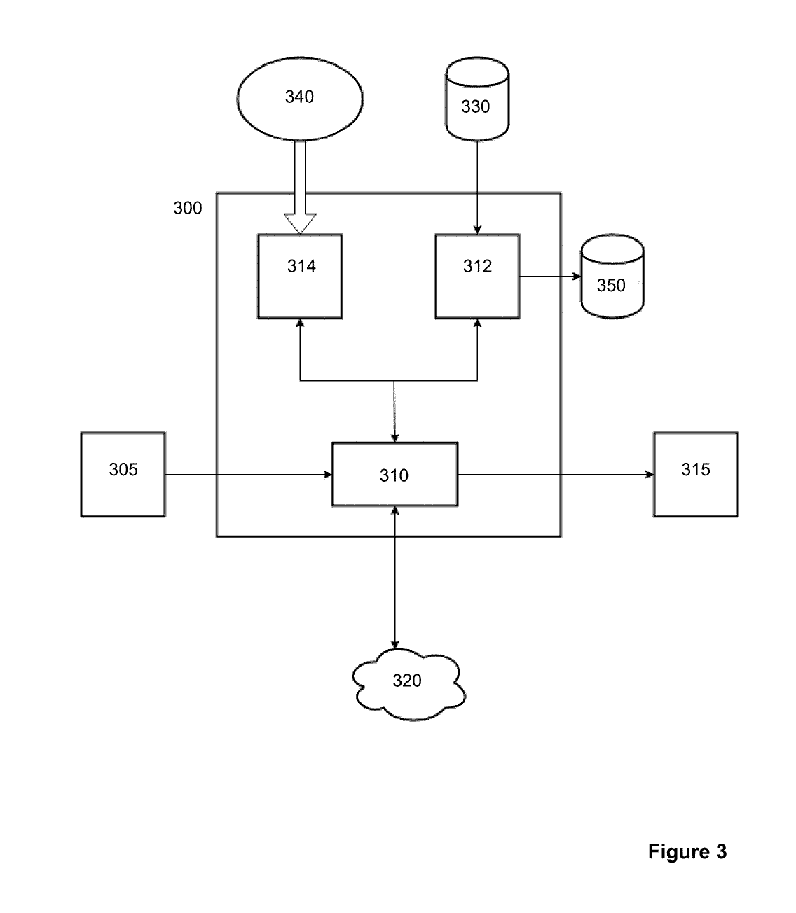

FIG. 3 illustrates a block diagram of one embodiment of a server 300 used to process received images and provide surveys. Server 300 can comprise a processor 310 communicatively coupled with volatile storage 312 (e.g., RAM) and non-volatile storage 314 (e.g., ROM). Processor 310 can be configured to receive various requests 305 and generate responses 315. For example, such requests could be received from one or more user devices such as when an image is captured for recognition by server 300. The responses 315 (e.g., which survey to send) can be sent in response.

As shown, when a request 305 (e.g., image data) is received by processor 310, the processor 310 can analyze the image using image recognition processes 320. Although shown remote from the server 300, it is contemplated that such processes could be stored directly on the server, such as in non-volatile memory 312.

As described above, survey data 330 such as various images of an object that could be captured can be preloaded onto server and stored in the non-volatile memory 312. In some embodiments, such as where server is located on a user device, a software application can be loaded into volatile memory 314 for use by processor 310, such as described above.

Operation logs 350 can be created and exported from non-volatile memory 312 on a periodic basis. During the image recognition, the image is compared to the stored images to see if there is a match or commonality between the images. The more commonality (e.g., overlap) between the images, the higher the assigned probability.

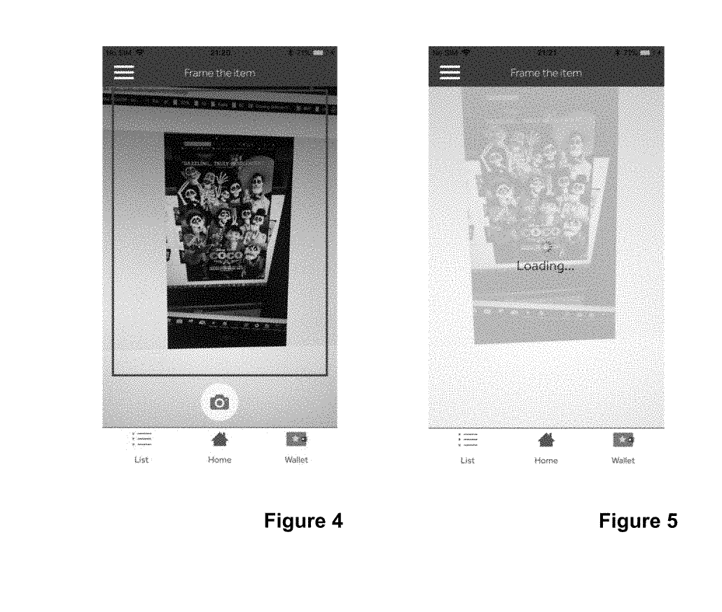

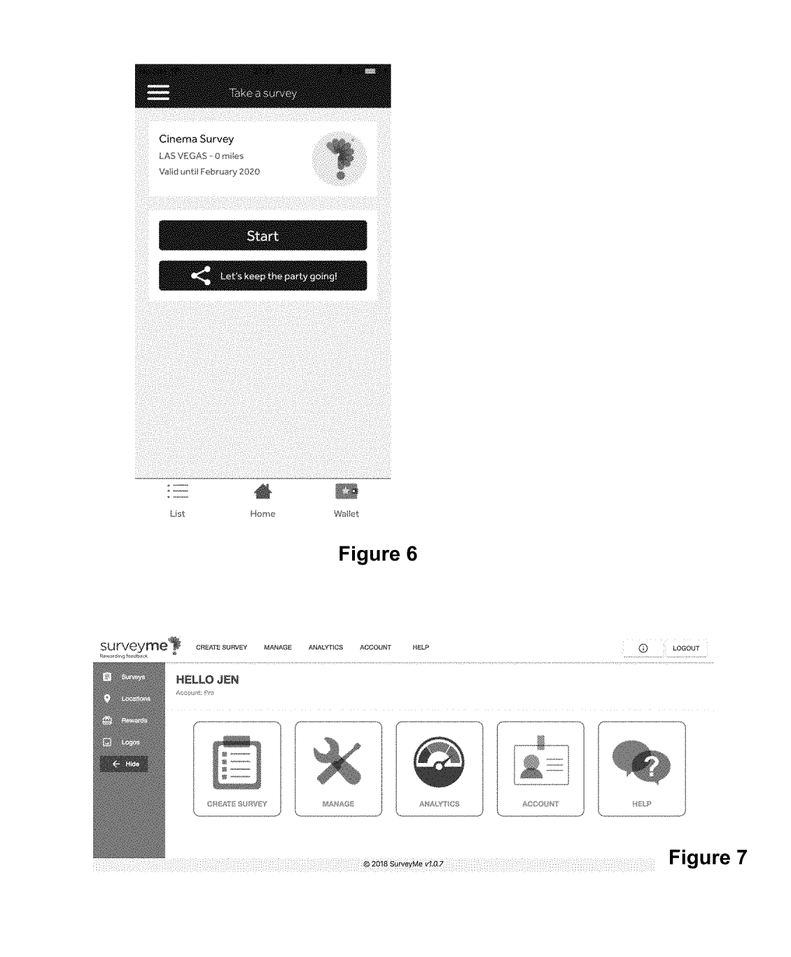

Exemplary screenshots of one embodiment of a software application for use on a user device, such as a smart phone, are shown in FIGS. 4-6. FIG. 4 illustrates a user interface where an object can be framed using the device's camera, for example. FIG. 5 illustrates an example of the interface after the image in FIG. 4 is captured. FIG. 6 illustrates that a survey can automatically be opened on the user device based on the captured image and the image recognition processes described above using the server.

In one aspect, surveys can be created that can be customized to a business's needs. For example, a company could add its logo, color scheme, and list specific questions to be answered, which could include text, images, and/or video. The answers could be provided via a toggle choice, multiple choice, free text, numeric rating range, photo/image, and/or information only. For example, it is contemplated that a company could login to a portal and be presented with an interface such as shown in FIG. 7, where surveys can be created and various reports could be viewed about survey redemption and other topics.

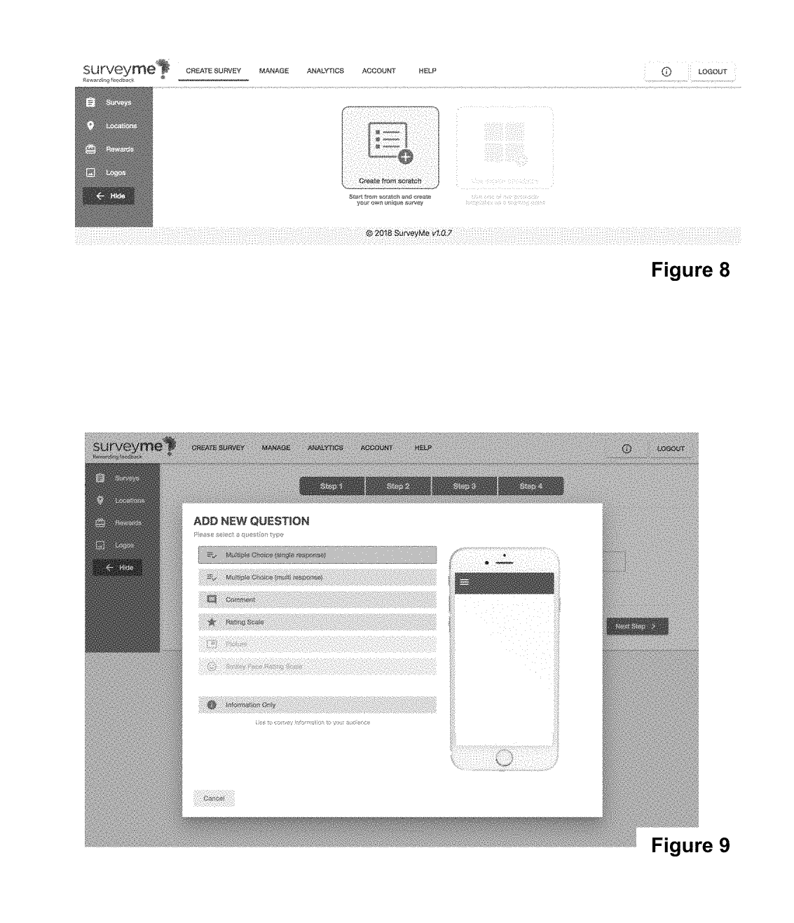

If the “create survey” link is clicked, it is contemplated that a survey creation interface such as that shown in FIG. 8 could be presented. This could include, for example, an option to create a survey from scratch and/or use a template to create the survey.

FIGS. 9-13 illustrates one embodiment of an interface for creating a survey. Using the interface as shown in FIGS. 9-13, a user can create a survey following a series of steps outlined below.

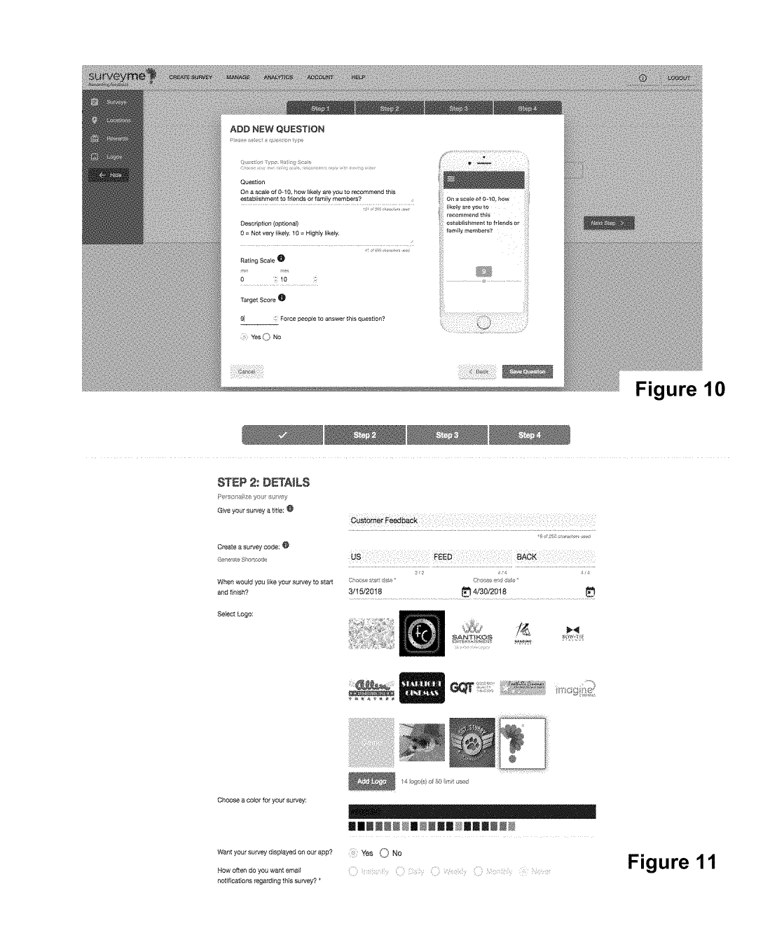

In FIG. 9, a user can add one or more questions to a survey using the interface shown. The questions could be configured to receive various types of responses such as multiple choice, free comment, ratings, and so forth. Using the interface, a user can select the type of question, and a prompt can appear as shown in FIG. 10. In this example, the user selected “Rating Scale”. The user can then enter the question's text, a description of the question (if necessary), and the parameters of the question. Using this interface, a user can select if the question needs to be mandatory to answer. The user can then click “Save Question” and has the option to either add another question or further configure the survey.

It is contemplated that the user can set up the parameters of the survey using an interface such as that shown in FIG. 11. This could occur before or after the survey questions have been prepared. Such parameters could include, for example, a survey title, a short code for accessing private surveys, start and end dates, logo(s) and branding colors.

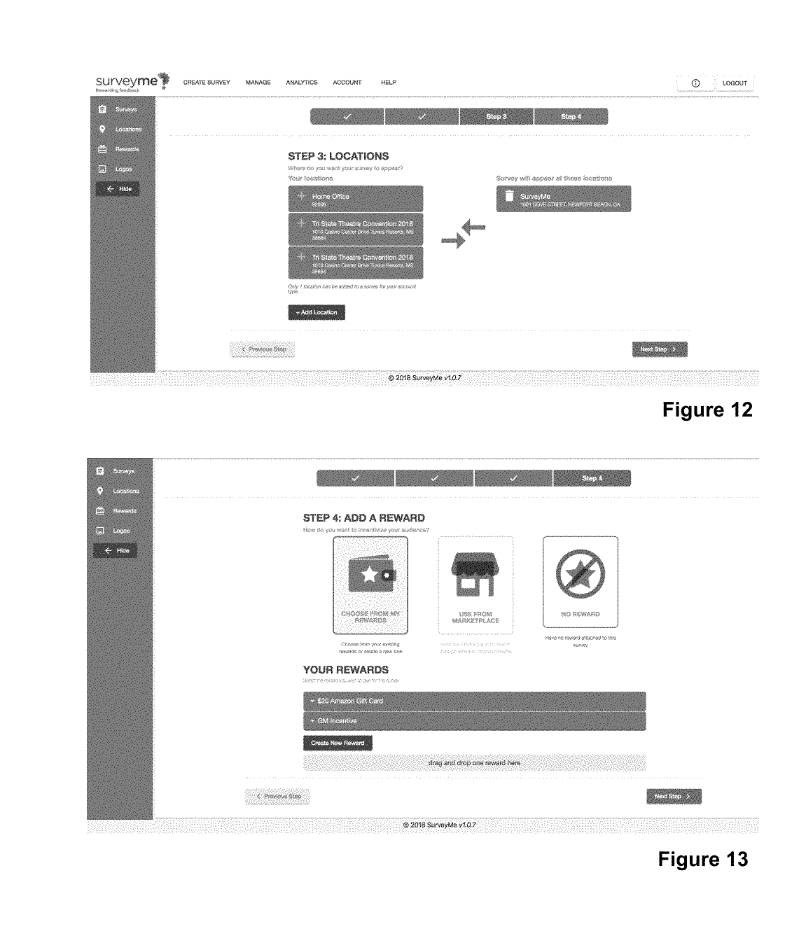

Using an interface such as that shown in FIG. 12, a user can also select which geographic location(s) where the survey should appear (e.g., the locations where when certain images are captured, a specific survey will be provided to the consumer). In other embodiments, the start page of the software application on the user device may be configured to act as a mobile advertising billboard, showing those surveys that can be accessed based on the location of the user device. For example, if a user is at a movie theater, certain surveys may be accessible that may not be accessible at other locations.

It is contemplated that locations can be selected using the “+” sign. The selection of locations determines the precise geolocation data stored in the server from which the software application requests surveys according to a location of the user device. As discussed above, the server could reside on the user device or be a remote server that is wirelessly accessible.

FIG. 13 illustrates an interface configured to permit a user to assign a reward for completion of the survey being created. It is contemplated that rewards can be selected from previous rewards within the account, a new reward created, or no reward selected.

The user interface shown in FIG. 7 can also be used to access information concerning existing surveys.

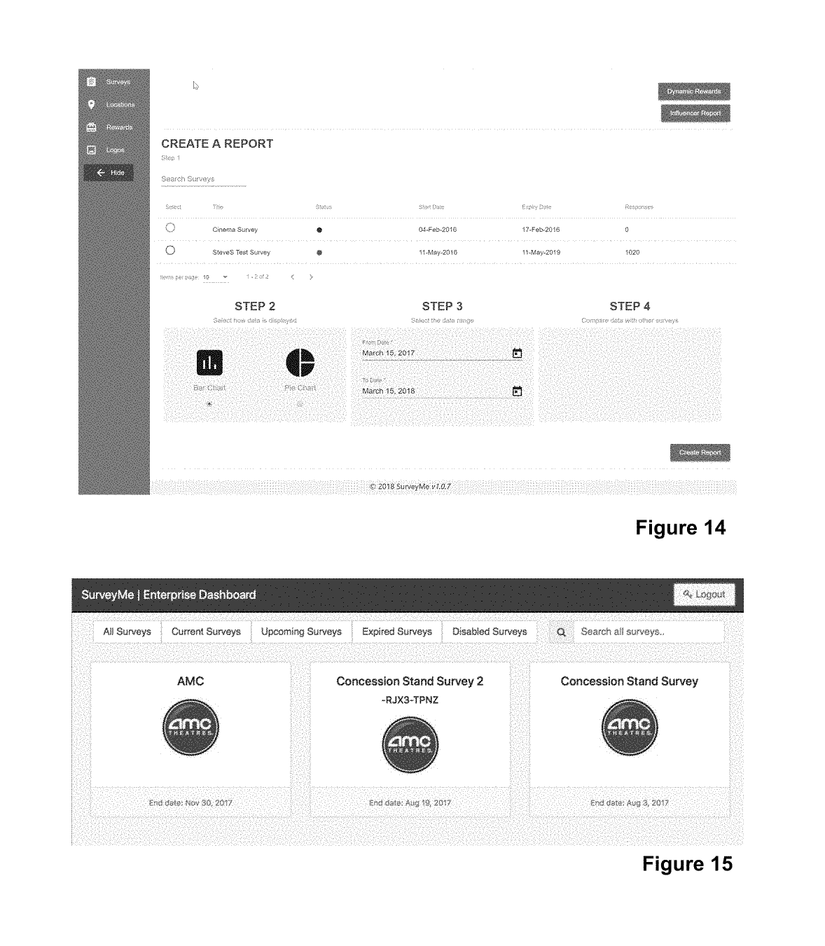

For example, a user can click the “analytics” link and an interface can be presented such as shown in FIG. 14, which presents a user with a list of surveys to be selected and the ability to vary a date range. This request is sent to the server which fulfills the requests and the interface presents the results. When the request is fulfilled, the interface can render that data into a series of charts and display those to the user.

It is contemplated that feedback from the server can return from the software application in approximately 1.5 seconds and is sorted into an interactive Dashboard such as that shown. The feedback can be filtered by a number of different parameters, including location, date range, and so forth. This is not limited to a single filter, any number of compound filters can be applied to drill down into the data.

The server can also transmit any saved filters that the user has previously created which can then be available via a drop down list box and are applied when selected. The current state of the filters can be saved at any time, and recalled at a later time. The filter(s) can be named by the user and transmitted to the server to be saved in the user's account, and could be saved locally as well.

This data can also be emailed or otherwise transmitted in various formats, such as a PDF™ or Excel™ document. It is contemplated that the interface can create the data object and transmit it the server where the data object is received and transmitted to the specified recipient. Reports can be created as repeatable events, so that a report can be generated automatically by the server, and transmitted according to a set schedule.

Responses can be displayed or provided to a company or other user via a raw data export, formatted graphical reports, immediate notification of a response via email or webhook/push notification, and so forth.

As shown in FIG. 15, the surveys corresponding to the user's request can be presented. A user can review information concerning a specific survey by clicking the survey of interest. Upon selecting a survey, the software application will request survey response data from the server.

In some embodiments, this data can be requested in a two-step process. First, a summary of response counts can be provided to the user with an initial view, while a detailed survey response model is being generated/loaded. Once loaded, the detailed survey response model can be presented.

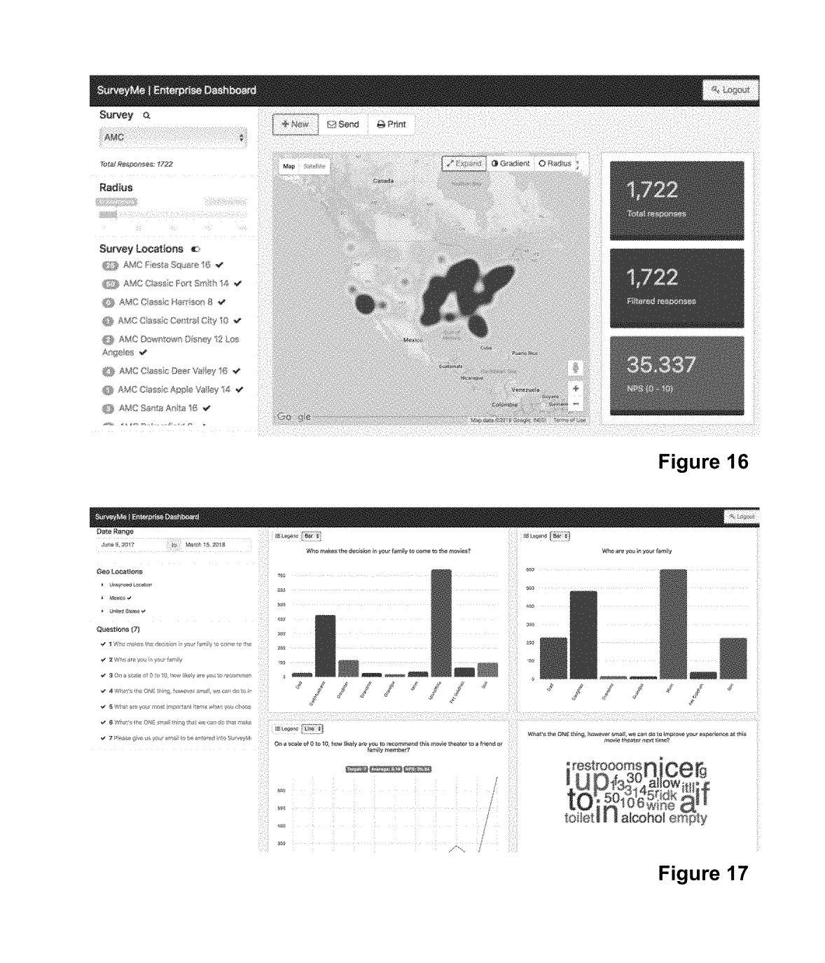

FIG. 16 illustrates an exemplary interface for presentation of detailed survey data to a user. As shown, a user can toggle between different surveys on the left-hand side, such as via a drop-down list. The user can also filter data by various parameters including, for example, radius, location, or date range. In the center, a heat map is shown that provides the geo-locations of all responses that correspond to the selected survey and parameters. On the right hand side, the user can view a total number of responses, a number of filtered responses (which dynamically updates as filters are modified), and a net promoter score of all locations.

FIG. 17 illustrates a continuation of FIG. 16, such as when the user scrolls down. The left hand side will show date ranges, geo locations, and questions than can be used to filter responses and data shown. Underneath the heat map, it is contemplated that each question can have its own box that can show responses in various forms such as a bar chart, pie chart, line graph, or word cloud when applicable.

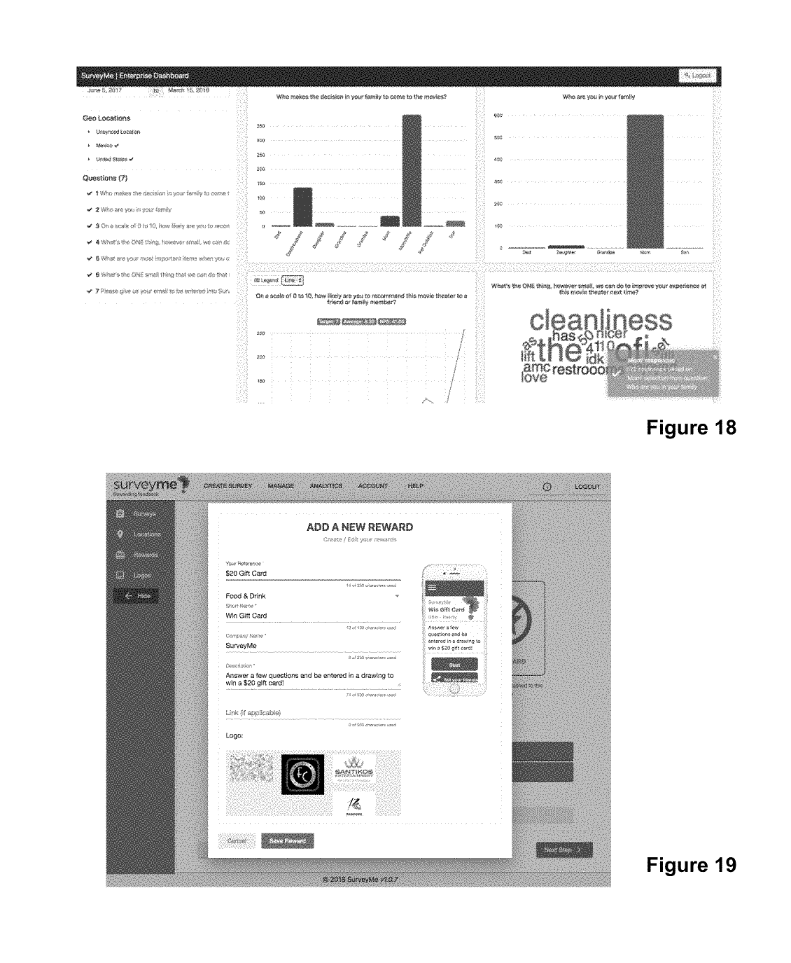

It is further contemplated that each bar can be clicked on to engage a filter. For example, assuming a user wants to know the comments from Moms that have taken the survey, the user would click Moms in the second question to engage the filter. A pop-up window (shown in the bottom right corner of FIG. 18) can appear to show which filter has been engaged.

FIGS. 19-22 illustrate examples of various user interfaces that can be used to create/add a reward to a survey.

FIG. 19 illustrates an exemplary interface for adding a reward to a survey such as by clicking the link shown in FIG. 13. Using the interface shown, a user can select from previously created rewards or create a new reward. On the “Add a New Reward” page, the user can add the following information: a private reference code; a reward category (e.g., Entertainment, Food & Drink, General, Retail, and Travel); a short name; a company name; a description; a link (if applicable); a logo; the Reward; and a repeat lockout. To counter abuse, the repeat lockout can be used to specify a he length of time that must pass before a specific user can receive the same reward again.

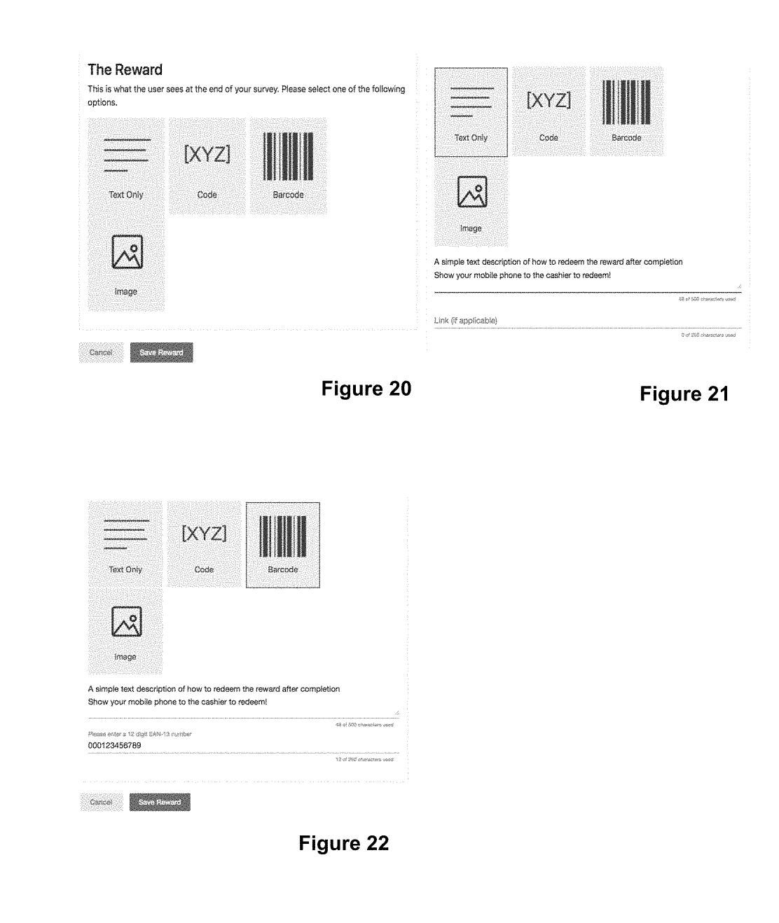

FIG. 20 illustrates an exemplary interface that shows the user how the reward will appear to the end user at the end of the survey. It is contemplated that the user could select plain text to show up with instructions on how to redeem the reward (see FIG. 21). Alternatively, the user could use a promo code, a barcode, or unique barcodes or other images that can be generated for redemption by a POS system. See FIG. 22.

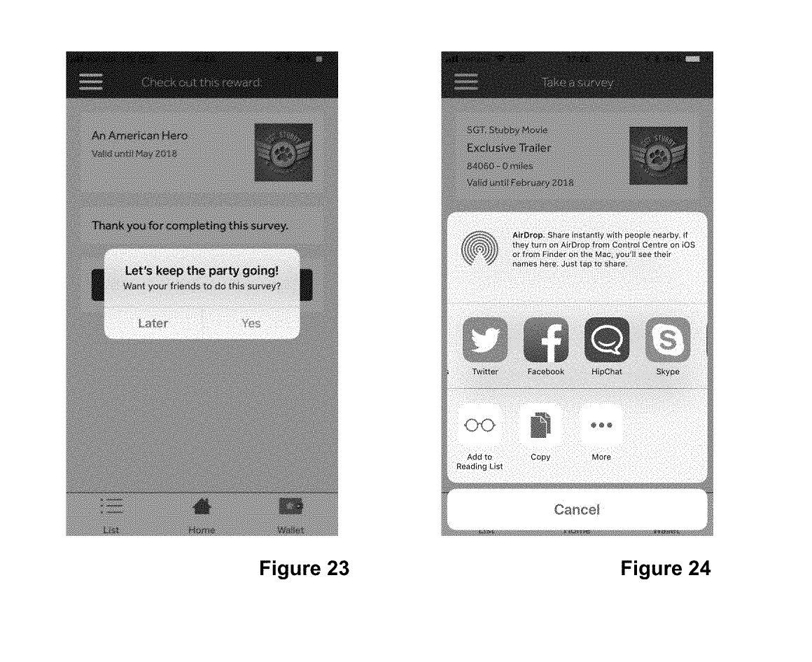

In another aspect, it is contemplated that a survey could be shared by a user with other users. For example, FIG. 23 illustrates how the interface may present an invitation to share the survey. A survey creator could permit sharing of a survey and even offer rewards as inventive to share the survey with others. This can be done by connecting the software application on the user device with one or more of the user's existing social media accounts which are already pre-loaded on the user device.

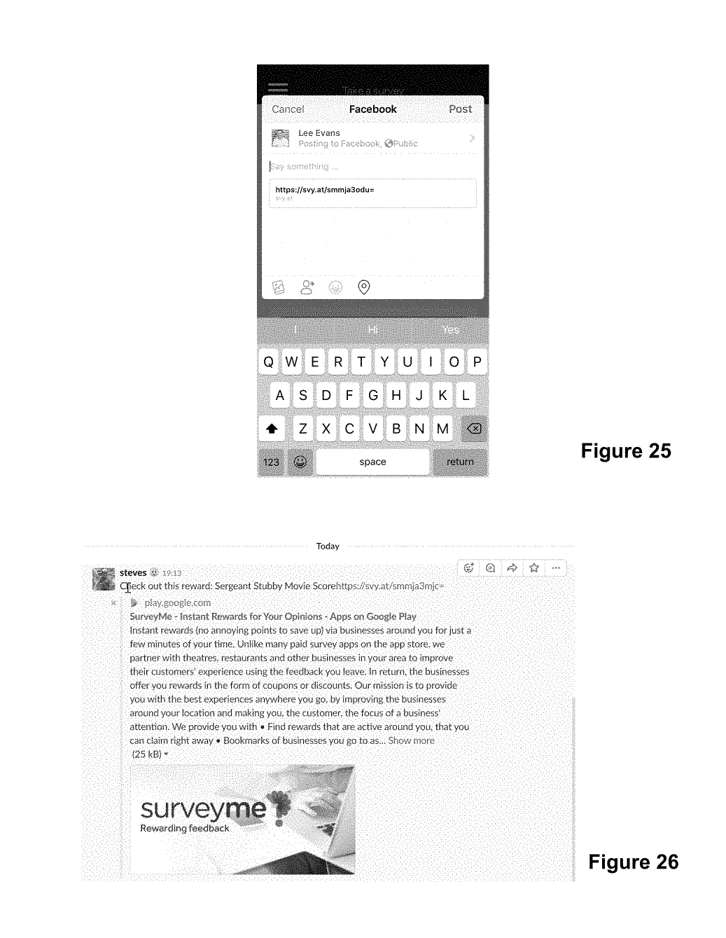

FIG. 24 illustrates the ability of a user to share a survey via the mobile device's social media connections. FIGS. 25-26 illustrate that a customizable message can open with a link to the software application or survey.

When preparing to share a survey, it is contemplated that the software application can request a unique link to share the survey. This unique link can be used by another to open the survey in the other user's software application or in a web browser, for example. The unique link can be monitored so that the user who shares the link may receive credit or other rewards when the shared survey is completed by others. For example, the software application may request information from the server about whether the link was shared and how many times the shared survey was completed.

When a request using a unique link is received by the server (from either the software application or the user attempting to use the unique link in a web browser), a request will be sent to the server to expand that link. The server may accept the request for expansion and perform a lookup on the incoming unique link. If the unique link is found in the non-volatile storage of the server, the related data is retrieved and a Share Link Model can be generated that contains pertinent date, including, for example, a survey identifier, a reward identifier, and other data to enable attribution of the share and download attribution via the application stores such as APPLE™ App Store™ or GOOGLE™ Play Store.

As an example, assuming a user does not have the designated software application installed on the user device, the user may instead be able to click a link and be directed to a location to download the App (e.g., APPLE™ or GOOGLE™ store). When the software application is installed, the Share Link Model information can be passed into the software application. The software application will then use the information to open the correct survey and attribute opening and/or completion of the survey to the user who shared the survey. This is accomplished by the software application transmitting to the server an indicator whether the survey associated with the Share Link Model was opened and completed and whether the software application was a new install or previously installed by that user.

As another example, assuming a user has the software application installed on the user device, using AppLinks/URL Association technology in Android and iOS, the software application will open. Once opened, the software application will send a unique identifier (e.g., “smmtkz” parameter) to the server, and the server will return the expanded Share Link Model to the software application. The software application will then use the data to open the correct survey and attribute the event to the user who shared the survey. This is accomplished by the software application transmitting to the server an indicator whether the survey associated with the Share Link Model was opened and completed and whether the software application was a new install or previously installed by that usere.

It is contemplated that there can be multiple levels of rewards for sharing a survey, which may be modified by the survey creator. As but one example, there could be a reward for simply sharing the survey (Reward A). Another reward could be offered when three different users complete the shared survey (Reward B). Yet another reward could be offered when twenty different users complete the shared survey (Reward C).

Upon receipt of a reward for sharing a survey, the software application can be configured to display a notification and/or badge. Clicking the notification may direct the user to the received reward.

To encourage growth of the platform, surveys can also be publicized to the public who may not currently have the software application (e.g., the SURVEYME™ app) installed. This could occur through, for example, digital advertisement on social media platforms that can provide a hyperlink to download the software application, or permit the survey to be completed via a website. Upon installation of the software application via the link, it is contemplated that the advertised survey could be automatically opened.

Printed promotional media could also be used containing the AppStore/GOOGLE Play store details to download the software application. For example, such printed media could contain a QR code or other unique identifier that a person can scan to direct the user device to the relevant location to download the software application, and start the survey once installed. In some embodiments, an NFC tag may be read to open the GOOGLE Play™ or APPLE™ App page, and start the survey once installed. Digital Marketing campaigns using email or SMS could also be used. In such embodiments, it is contemplated that a pre-programmed NFC tag could be placed at a specific location (e.g., a counter, a wall, a digital sign, etc.). Depending on the location of the NFC tag, a survey can be remotely associated such that when a user scans the NFC tag, the user receives the survey or is directed to download the software application.

Surveys can be publicized to users who already have installed the software application by any of the above methods, as well as a user clicking or tapping on a digital advertisement on a device with the software application installed, which can open the software application and start the advertised survey.

It is contemplated that rewards may be publicized using the same methods described above in relation to the surveys. For example, rewards can be publicized as part of a survey with a reward delivered to the user upon survey completion. All the details of the reward will have been sent with the survey data required to take the survey. This is so that a user using the software application can still take advantage of the reward in the event of a loss of internet access. At the end of the survey, the reward can be placed in the user's wallet stored within the software application. Rewards can also be publicized as part of a bonus, as discussed below.

Rewards can also be removed in various manners. For example, a user may decide to delete a reward using the user interface in the software application. Upon deletion, information is sent to the server to state the specific reward with a specific reward identifier was deleted without being used by the user. A reward can also be removed once redeemed, as described above. In addition, it is contemplate that the software application may periodically poll the server for a list of rewards to be removed from users' wallets. This could be because promotion has ended or expired. Upon receiving a list of reward identifiers from the server, the software application will delete any matching rewards in the wallet of the software application.

It is also contemplated that a user who previously responded to a survey may be notified if there is an update to that survey, such as an additional question. In addition, a survey could be disabled for a user for a specific period of time or indefinitely, once the user has responded or based on other factors.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for providing a survey to a user device, comprising:
a server receiving a survey request from a user device, wherein the survey request comprises location information of the user device and captured image information;
analyzing the location information and captured image information of the survey request using the server to generate request attributes;
comparing the request attributes to a set of surveys to assigning a probability to each of the surveys;
selecting a subset of surveys having an assigned probability that meet or exceed a predetermined threshold; and
sending the subset of surveys to the user device.

2. The method of claim 1, further comprising:
upon completion of the survey, the server receiving the completed survey from the user mobile device; and
sending a reward to the user device.

3. The method of claim 2, wherein the reward comprises a digital coupon.

4. The method of claim 2, wherein the reward is based at least in part on a location of the user mobile device.

5. The method of claim 1, wherein the image information comprises an image of an object captured by the user device.

6. The method of claim 1, wherein the information is captured by the user device using a camera or a NFC tag reader.

7. The method of claim 1, wherein the survey request comprises an image, and wherein the step of comparing the request attributes further comprises comparing attributes of the image with attributes of stored images on a server, where each of the stored images is associated with a survey, and wherein the probability is based on whether attributes of the captured image matches attributes of one or more of the stored images.

8. The method of claim 1, further comprising causing the user mobile device to automatically open the selected survey upon receipt.

9. A method of facilitating redemption of a coupon or other reward at a merchant, comprising:
receiving a request from a user to redeem a digital reward stored in a software application of a user device;
the software application causing the user device to capture one or more images during redemption of the reward at a merchant;
sending at least one of the captured images to a server;
analyzing the at least one captured image to determine a likelihood that the image shows a redemption of the reward;
the server sending a command to the merchant to accept the reward if the likelihood is greater than a predetermined threshold;
the server sending a first command to the user device to cause the software application user mobile device to delete the one or more captured images; and
the server sending a second command to the user device to cause the user device to deactivate or remove the reward.

10. The method of claim 9, wherein the step of sending the at least one captured image further comprises sending a location information of the user device at the redemption of the reward.

11. The method of claim 10, further comprising:
comparing the location information of the user device with a set of known locations of the merchant to calculate a minimum distance between the location of the user device and the merchant; and
the server sending the command to the merchant to accept the reward only if the minimum distance is less than a predetermined threshold.

12. The method of claim 9, wherein the software application causes the user device to capture the one or more images when a laser from a point-of-sale system of the merchant scans the reward on the user device during the redemption.

13. The method of claim 9, wherein the software application causes the user device to capture a series of images beginning when the digital reward is presented on the user device, and wherein the series of images are taken at a periodic interval until the first command is received from the server.

14. The method of claim 13, wherein the periodic interval is at least one image per second.

15. The method of claim 13, wherein the periodic interval is at least two images per second.

16. The method of claim 13, wherein the periodic interval is at least four images per second.
